(19) United States
(12) Patent Application Publication
(10) Pub. No.: US 2021/0004172 A1
(43) Pub. Date: Jan. 7, 2021

(54) DATA PROCESSING SYSTEM, DATA PROCESSING APPARATUS, AND COMPUTER-READABLE RECORDING MEDIUM HAVING STORED THEREIN A DATA PROCESSING PROGRAM

(71) Applicant: FUJITSU LIMITED, Kawasaki-shi (JP)

(72) Inventors: MASARU SHIMMITSU, Kawasaki (JP); Osamu KIMURA, Kawasaki (JP); Hiroshi Shiomi, Kawasaki (JP); Takako Kato, Setagaya (JP); Yoichi YASUFUKU, Machida (JP)

(73) Assignee: FUJITSU LIMITED, Kawasaki-shi (JP)

(21) Appl. No.: 16/906,537

(22) Filed: Jun. 19, 2020

(30) Foreign Application Priority Data
Jul. 1, 2019 (JP) 2019-123083

(51) Int. Cl. G06F 3/06

(52) U.S. Cl. CPC G06F 3/0649; G06F 3/067; G06F 3/0638; G06F 3/0616

(57) ABSTRACT

A data processing system includes a storage apparatus having a plurality of data storages and a processing control apparatus, the processing control apparatus is configured to: calculate hash information from data; and uniquely decide an arrangement destination of the data in the plurality of data storages according to the calculated hash information, and the storage apparatus is configured to: move specific data specified as a movement processing target among a plurality of pieces of stored data stored in the data storage from the arrangement destination of the specific data to a movement destination; and write information on a storage position of the specific data to the arrangement destination of the specific data after the movement.

### CROSS-REFERENCE TO RELATED APPLICATION

This application is based upon and claims the benefit of priority of the prior Japanese Patent Application No. 2019-123083, filed on Jul. 1, 2019, the entire contents of which are incorporated herein by reference.

### FIELD

The examples discussed herein are related to a data processing system, a data processing apparatus, and a computer-readable recording medium having stored therein a data processing program.

### BACKGROUND

In recent years, an amount of data handled in an information processing apparatus increases more exponentially as being referred to as an information explosion. There s a change in a type of data to be preserved for such large amounts of data. In the related art, there is a strong tendency for only important data to be preserved. On the contrary, with a spread of a method in which data groups considered worthless are associated with each other and analyzed to sublimate the data groups to worthwhile information in recent years, all of the generated data tend to be stored. Due to the tendency, there is a further rise in the amount of data to be preserved.

Japanese Laid-open Patent Publication No. 2008-112276 and Japanese Laid-open Patent Publication No. 2016-157266 are examples of related art.

### SUMMARY

According to an aspect of the embodiments, a data processing system includes a storage apparatus having a plurality of data storages and a processing control apparatus, the processing control apparatus is configured to: calculate hash information from data; and uniquely decide an arrangement destination of the data in the plurality of data storages according to the calculated hash information, and the storage apparatus is configured to: move specific data specified as a movement processing target among a plurality of pieces of stored data stored in the data storage from the arrangement destination of the specific data to a movement destination; and write information on a storage position of the specific data to the arrangement destination of the specific data after the movement.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of an object storage system;

FIG. 2 is a sequence diagram representing access to an OSD using a hash method by a gateway apparatus;

FIG. 3 is a block diagram of the gateway apparatus;

FIG. 4 is a diagram representing an example of an object information management table;

FIG. 5 is a diagram representing assignment of PGs to OSDs;

FIG. 6 is a diagram representing an example of an object movement plan management table;

FIG. 7 is a block diagram of a management apparatus;

FIG. 8 is a diagram representing an example of an OSD capacity management table;

FIG. 9 is a diagram representing reconstruction of PGs by rebalancing;

FIG. 10 is a flowchart of an operation of capacity securing movement processing performed by the management apparatus according to Example 1;

FIG. 11 is a flowchart of an operation of capacity securing movement processing performed by the gateway apparatus according to Example 1;

FIG. 12 is a flowchart of an operation of capacity securing movement processing performed by the OSD according to Example 1;

FIGS. 13A and 13B are a flowchart of return processing of an object performed by an object storage apparatus according to Example 1; and

FIG. 14 is a hardware configuration diagram of the object storage system.

### DESCRIPTION OF EMBODIMENTS

An object storage has been proposed as a storage that meets a demand for preservation of large amounts of data. The object storage provides secure preservation of large amounts of data and large-scale data in a single system, which may not be done in a storage apparatus in the related art. The object storage handles data in object units instead of file or block units. An object ID (identifier) which is unique identification information in a storage system is assigned to an object, and the object is configured of data and metadata for handling the data.

However, the amount of data is small at the beginning of the introduction in many cases even in a system in which the large-scale data is assumed. Therefore, it is uneconomical to construct a large-capacity storage system from the beginning in anticipation of a final amount of data. It is also difficult to predict a pace of increase in data in a design stage of the system. Therefore, it is desirable to provide a configuration in which a small-scale storage is prepared in the introduction stage and the capacity of the storage is gradually added in consideration of a result of increase in the amount of data. The object storage is configured of a distributed file storage in which general-purpose storages are parallelized in many cases and is capable of scale-out.

In the distributed file storage such as the object storage, the data is distributed and arranged in a large number of devices, and thus management of a storage location of the data is important. There are a metadata method and a hash method as a method for managing the storage location of the data in the object storage. In the metadata method, a metadata server is inquired about the location of the data every time each input/output (I/O) is executed. Therefore, an overhead due to the inquiry about the location of the data is generated every time in the metadata method. On the other hand, in the hash method, hash information is obtained from the object while the metadata server is not provided, and data access is performed by using the calculated hash information. In the hash method, target data may be accessed only by calculation, and thus the overhead generated at the time of the I/O execution is small. In the hash method, although information used for the hash calculation is checked with respect to a monitoring apparatus called a monitor before the access starts, the overhead due to the inquiry is not generated as long as the configuration is not changed. For example, it is preferable to employ the hash method in order to suppress the overhead at the time of the I/O execution.

Each object is assigned to a group called “placement group (PG)”. In the hash method, a PG which is a storage destination of the object is decided by a hash value calculated from the object ID, and the object is stored according to an arrangement designated by the PG. Each object is physically stored in an object storage device (OSD) that is a set of a disk, which is an actual storage for actually storing data, and an OSD daemon, which is a control program for controlling the disk to arrange object data. The PG extends across a plurality of OSDs to secure redundancy. For example, even in a case where any one of OSDs included in a certain PG fails, data stored in the OSD in which the failure occurs may be restored by using data stored in other OSDs included in the PG. Each PG includes a combination of various OSDs since there are a lot of OSDs. Therefore, the more PG is, the more types of the combinations of the OSD included in each PG are, and the smaller a deviation in the data arrangement is. The OSD included in the PG is decided by a pseudo-random number.

In a case where the OSD is added, the assignment of the PG to each OSD is recalculated. Accordingly, a set of OSDs included in some PGs is changed. Data of the PG for which the configuration of the OSD is changed is rearranged in a new set of OSDs. Data present in an OSD that is present in the set before the change and is not present in the set after the change is deleted after the rearrangement is completed.

For the data arrangement in the storage, there is a related art in which a virtual volume over a storage pool is rearranged based on a pool use amount and a use prediction. There is a related art of a distributed file system in which data is distributed and arranged by using a hash value of a file name.

However, the PG is assigned to the OSD using the pseudo-random number in the object storage. For this reason, a probability in the object storage that the PG is assigned to each OSD is different from a case where the PG is equally assigned to each OSD, and thus the deviation in the OSD where the objects are arranged may occur. For example, the variation in a set of OSDs Included in each PG is smaller as the number of PGs is smaller due to a small configuration, and the deviation in the data arrangement is more likely to occur. For example, it is considered that there are an OSD in which four PGs are assigned and an OSD in which three PGs are assigned. In this case, there is a high possibility that the OSD in which four PGs are assigned has a higher storage amount of the object than the OSD in which three PGs are assigned. There may be a case where the deviation in the hash information calculated from a large number of object IDs occurs and thus a lot of objects gather in a specific PG.

When the deviation in the amount of objects to be stored occurs between the OSDs, in a case where a part of storage devices constituting the storage pool reaches an upper limit of a capacity, it becomes difficult to write the object even in a state where there is a free capacity in the other devices. In a case where the data access by the hash method is used, even when a new storage device is added in the case where the storage device reaches the upper limit of the capacity, it is not known whether the new storage device becomes a writing destination since the writing destination of the object is decided by the hash value. In this case, the storage whose capacity reaches the upper limit may be the writing destination of the object, and thus it is difficult to remove writing limitation. In the case where the data access by the hash method is used, when an arrangement destination of a preserved object is simply changed, it is difficult to access a desired object due to difficulty in searching for a movement destination and thus a storage service may be stopped.

In a case where the storage of the object is concentrated in a specific OSD, a data distribution ratio may be decreased to perform the rearrangement. In this case, the set of OSDs included in each PG is changed. However, the movement of the object is not directly performed, and it takes time until the free capacity is actually available since rebalancing occurs for each update. Since the PG assigned to the OSD is decided by the same calculation as in a normal case, the PG may be assigned to an OSD that already stores a large number of objects. In this case, the free capacity of the OSD as the movement destination becomes tight and the rearrangement is performed again. Therefore, it is difficult to immediately and reliably perform the writing of the object and thus the storage service may be stopped.

In the related art in which data is rearranged based on the pool use amount and the use prediction, in the case of the data access by the hash method, there may be difficulty in writing or reading of the object due to the simple movement of the data or the movement by the change in the data distribution ratio. In the related art in which the data is distributed and arranged by using the hash value, it is possible to shorten a movement time of the data. However, there may be difficulty in writing or reading of the object since a capacity of the movement destination or an appropriate selection of the data to be moved is not taken into consideration.

Techniques disclosed herein have been made in view of the above, and a data processing system, a data processing apparatus, and a data processing program that maintain continuity of a storage service may be provided.

Hereinafter, examples of a data processing system, a data processing apparatus, and a data processing program disclosed in the present application will be described in detail with reference to accompanying drawings. The data processing system, the data processing apparatus, and the computer-readable recording medium having stored therein the data processing program according to the present application are not limited by the following examples.

### Example 1

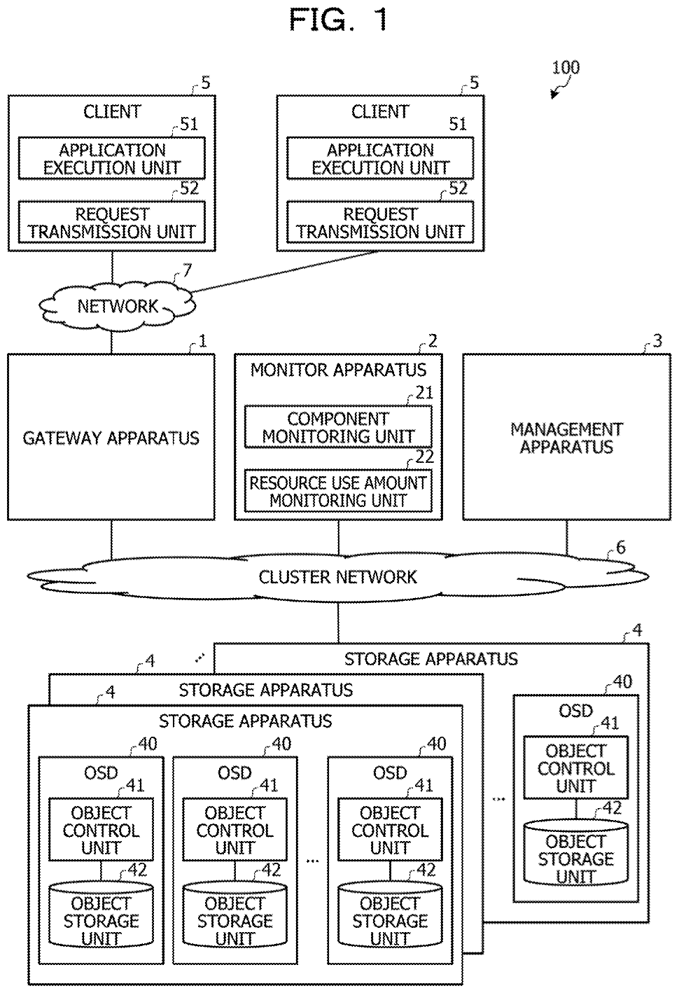

FIG. 1 is a configuration diagram of an object storage system. As represented in FIG. 1, an object storage system 100 which is a data processing system includes a gateway apparatus 1, a monitor apparatus 2, a management apparatus 3, and a storage apparatus 4. The gateway apparatus 1, the monitor apparatus 2, the management apparatus 3, and the storage apparatus 4 are coupled with one another through a duster network 6 which is an internal network of the object storage system 100.

A client 5 is an apparatus that transmits, from the outside, an access request for instructing the object storage system 100 to perform reading or writing of an object. The client 5 includes an application execution unit 51 and a request transmission unit 52. Two clients 5 are described in FIG. 1, but the number of clients 5 is not particularly limited.

The application execution unit 51 executes, for example, an application that performs processing by using data stored in the object storage system 100. The application execution unit 51 outputs, to the request transmission unit 52, the access request such as reading or writing for the object that occurs during the execution of the application. Thereafter, the application execution unit 51 receives a response to the access request through the request transmission unit 52 and continues the processing by executing the application.

The request transmission unit 52 receives an input of the access request for the object from the application execution unit 51. The request transmission unit 52 transmits the access request to the gateway apparatus 1 through a network 7 which is an external network such as the Internet. Thereafter, the request transmission unit 52 receives the response to the access request from the gateway apparatus 1. The request transmission unit 52 outputs the acquired response to the access request to the application execution unit 50.

One or more storage apparatuses 4 are arranged in the object storage system 100. In the present example, a plurality of storage apparatuses 4 are arranged. The storage apparatus 4 is managed in units of a storage pool in which a plurality of storage apparatuses are collected.

The storage apparatus 4 includes a plurality of OSDs 40. The OSD has a set of an object control unit 41 and an object storage unit 42. The object storage unit 42 stores an object. The object storage unit 42 has an actual storage such as a hard disk that actually stores the object. The object control unit 41 controls an object arrangement management in the object storage unit 42 in the storage apparatus 4, the storage of the object in the actual storage, redundancy, and the like. The object control unit 41 corresponds to an example of a “movement unit”, and the object storage unit 42 corresponds to an example of a “data storage unit”.

The gateway apparatus 1 is coupled with the client 5 through the network 7 which is the external network. The gateway apparatus 1 provides, to the client 5, an interface to the storage apparatus 4 which is an object storage. The gateway apparatus 1 is converted from a general-purpose interface with which the client 5 is coupled into an internal interface.

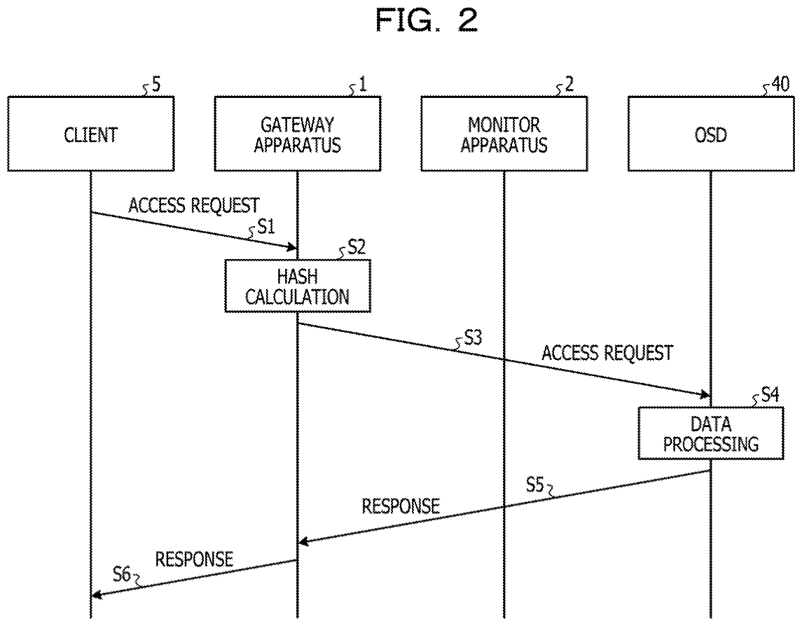

The gateway apparatus 1 executes access to the OSD 40 by the hash method. FIG. 2 is a sequence diagram representing the access to an OSD using the hash method by the gateway apparatus.

The gateway apparatus 1 receives the access request for the storage apparatus 4 transmitted from the client 5 (step S1). The gateway apparatus 1 performs a hash calculation using an object designated by the access request to obtain hash information (step S2). Next, the gateway apparatus 1 performs the access request to the OSD 40 by using the obtained hash information (step S3).

The OSD 40 receives the access request and executes data processing such as writing or reading of an object with a position uniquely decided by the hash information as an arrangement destination (step S4). Thereafter, the OSD 40 transmits the response to the gateway apparatus 1 (step S5).

The gateway apparatus 1 receives the response from the OSD 40 and transmits the received response to the client 5 (step S6). The gateway apparatus 1 inquires of the monitor apparatus 2 about the information used for the hash calculation once before the access is started, but does not perform a subsequent inquiry unless a configuration of the OSD 40 is changed.

In a case where an unwritten capacity of the OSD 40 becomes small and a writing service may be stopped, the gateway apparatus 1 receives an instruction to move the object from the management apparatus 3. The gateway apparatus 1 executes the movement of the object in response to the instruction. The processing of moving the object will be described in detail below. The gateway apparatus 1 corresponds to an example of a “processing control apparatus”.

Returning to FIG. 1, the description is continued. The monitor apparatus 2 performs configuration management of the OSD 40, duster management of the storage apparatus 4, and a living confirmation of the gateway apparatus 1 and the management apparatus 3. The monitor apparatus 2 includes a component monitoring unit 21 and a resource use amount monitoring unit 22.

The component monitoring unit 21 monitors a resource state in each storage pool in which the plurality of storage apparatuses 4 are collected as one group. For example, the component monitoring unit 21 monitors an increase or decrease in the storage apparatus 4 and the OSD 40. The component monitoring unit 21 responds to the inquiry from the management apparatus 3 with the increase or decrease in the storage apparatus 4 and the OSD 40.

The resource use amount monitoring unit 22 monitors a written capacity of each OSD 40. The resource use amount monitoring unit 22 notifies the management apparatus 3 of the written capacity of each OSD 40 which is a monitoring result.

The management apparatus 3 provides a user interface to an administrator who manages the object storage system 100. In the monitoring and configuration change of the component, the management apparatus 3 executes processing of assisting the monitor apparatus 2, such as execution of a command or information provision. The management apparatus 3 executes control of the movement of the object.

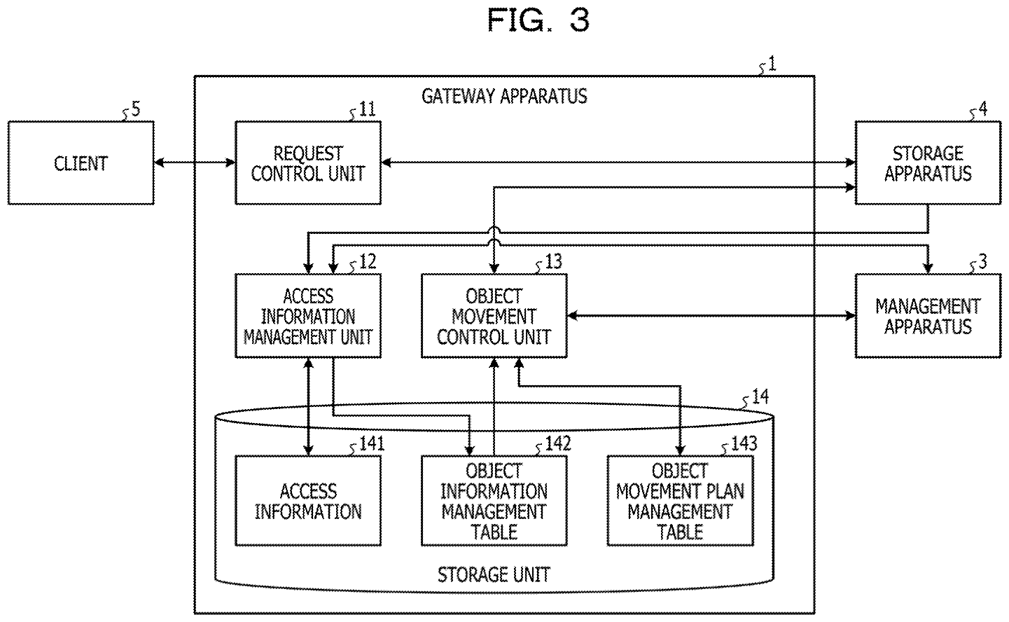

FIG. 3 is a block diagram of the gateway apparatus. The gateway apparatus 1 includes a request control unit 11, an access information management unit 12, an object movement control unit 13, and a storage unit 14.

The storage unit 14 is a storage medium such as the hard disk. The storage unit 14 includes access information 141, an object information management table 142, and an object movement plan management table 143.

The access information 141 is a record of access to the OSD 40. Information on the access to the OSD 40 in the past is accumulated in the access information 141. The access information includes, for example, a storage timing of the object, an access frequency representing the number of times of access per unit time, and a preservation expiration period of the object.

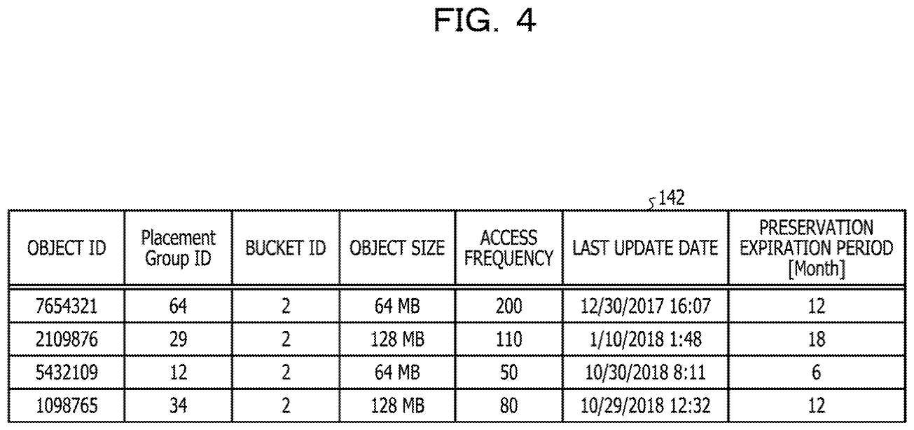

The object information management table 142 is a table in which the latest information of each object is registered. FIG. 4 is a diagram representing an example of an object information management table. Information on each object is registered in the object information management table 142, in association with an object ID which is an identifier of each object. The object ID is information obtained by calculating a hash value by multiplying a hash function by an object name. For example, placement group (PG)-ID, bucket ID, object size, access frequency, last update date, and preservation expiration period are registered in the object information management table 142.

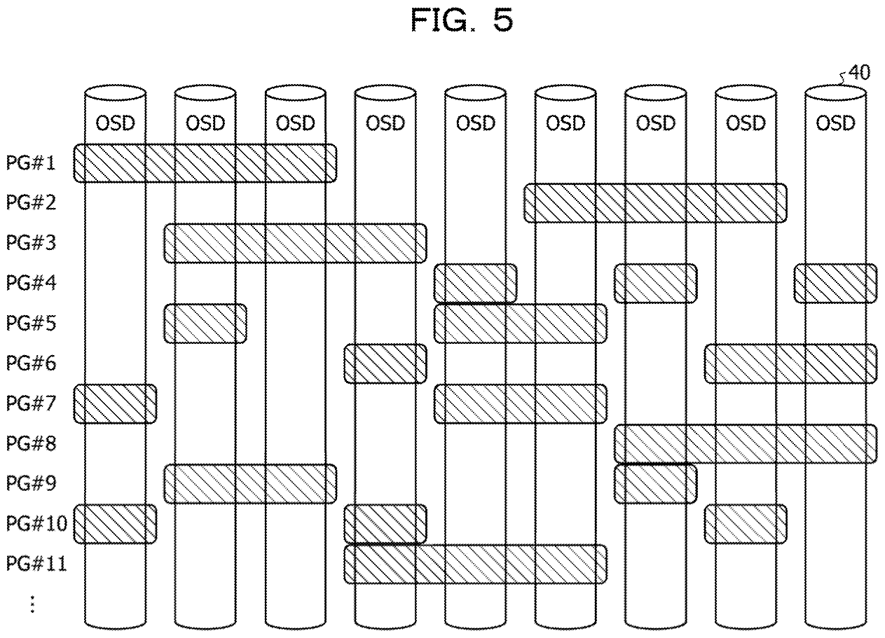

The PG is a unit for managing the object under conditions such as redundancy and a preservation period. As represented in FIG. 5, one PG is assigned to the plurality of OSDs 40. FIG. 5 is a diagram representing assignment of PGs to OSDs. Each PG constitutes a redundant group. In FIG. 5, three OSDs 40 are assigned to one PG, and thus the PG may be restored even when any one of the OSDs 40 fails. The PG-ID is an identifier of the PG to which the object belongs. PGs #1 to #11 in FIG. 5 correspond to PG-IDs.

Returning to FIG. 4, the description is continued. The object is stored in a preservation area called a bucket. A bucket ID is information representing the bucket in which the object is stored. The object size is information representing a size of the object. In this example, the object size has a data division size of 4 MB. The access frequency is a frequency at which the access such as writing or reading is performed for the object in a predetermined period. The last update date is a date and time at which the object is last updated. The preservation expiration period is a remaining period during which the object is preserved.

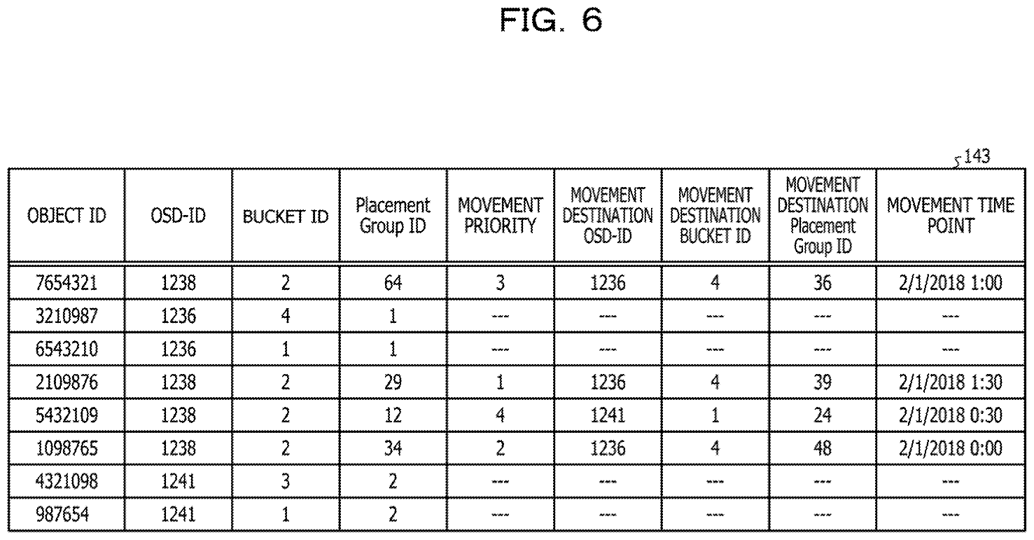

The object movement plan management table 143 is a table in which information on the movement of each object is registered. FIG. 6 is a diagram representing an example of an object movement plan management table. The object movement plan management table 143 also stores the information on each object movement in association with the object ID. For example, the object movement plan management table 143 registers OSD-ID, bucket ID, PG-ID, movement priority, movement destination OSD-ID, movement destination bucket ID, movement destination PG-ID, movement time point, and the like.

The movement priority is information registered in a case where the object is moved and represents a priority in a case where each object is set as a movement target. The movement destination OSD-ID, the movement destination bucket ID, and the movement destination PG-ID are information registered in a case where the object is moved in order to secure the capacity of the OSD 40. The movement destination OSD-ID is information on an OSD of a movement destination where the object is moved. The movement destination bucket ID is information on a bucket of the movement destination where the object is moved. The movement destination PG-ID is information on a PG of the movement destination where the object is moved. The movement time point is information representing a time point at which the object is moved.

Returning to FIG. 3, the description is continued. The request control unit 11 receives the access request from the client 5. Next, the request control unit 11 obtains the hash information of the object designated by the access request. The request control unit 11 transmits the access request to the storage apparatus 4 together with the hash information. For example, the request control unit 11 executes reading or writing of the object to an arrangement position uniquely decided by the hash information.

Thereafter, the request control unit 11 receives the response to the access request from the storage apparatus 4. For example, in a case where the access request is a reading request, the request control unit 11 receives an object at the arrangement position uniquely decided by the hash information as the response to the access request. In a case where the access request is a writing request, the request control unit 11 receives, from the storage apparatus 4, a response of writing completion of the object to the arrangement position uniquely decided by the hash information. Thereafter, the request control unit 11 outputs, to the client 5, the response to the access request. The request control unit 11 corresponds to an example of an “arrangement destination deciding unit”.

The access information management unit 12 receives, from the storage apparatus 4, the access information including the information on a preservation start timing, the access frequency, and a limited preservation period for each object. The access information management unit 12 registers the acquired access information as the access information 141 and accumulates the access information. The access information management unit 12 registers the information on each object in the object information management table 142 with reference to the access information 141. For example, the access information management unit 12 calculates a remaining preservation period using the information on the preservation period and the information on the preservation start timing and registers the remaining preservation period in the object information management table 142 as the preservation expiration period.

In a case where the object is moved, the access information management unit 12 receives a transmission request for information of an object to be moved from the management apparatus 3. The access information management unit 12 reads the information of the object that receives the request from the object information management table 142 and transmits the information to the management apparatus 3.

The object movement control unit 13 actually moves the object stored in the OSD 40 of the storage apparatus 4. The movement of the object performed for securing the capacity of the OSD 40 in a case where a storage capacity of the OSD 40 becomes close to an upper limit value thereof is referred to as “capacity securing movement”. In a case where the capacity securing movement is performed, the object movement control unit 13 receives, from the management apparatus 3, an instruction to decide the priority of the object together with the information on the OSD 40 which is a movement source.

The object movement control unit 13 has a determination condition for priority ranking in advance. The determination condition includes, for example, the following first to fourth conditions. The first condition is a condition that the priority is higher as an arrival date and time of the preservation period is closer. The second condition is a condition that the priority is higher as a preservation date and time, which is a written date and time, is earlier. The third condition is a condition that the priority is higher as the access frequency is lower. The fourth condition is a condition that the priority is higher as the object size is larger. The determination condition may include other conditions as long as an influence due to a movement other than the capacity, such as using a storage area of the OSD 40 of the movement destination for a long term, is small and the capacity may be secured as much as possible in a case where the object is moved. The determination condition may be one or some of the above first to fourth conditions.

The object movement control unit 13 decides the priority of the movement based on the first to fourth conditions for the object stored in the movement source OSD 40. The object movement control unit 13 registers the decided priority in the object movement plan management table 143 in association with the respective objects. The object movement control unit 13 may register information of all objects or may register the object of the OSD 40 to be moved In the object movement plan management table 143. For example, in the object movement plan management table 143 represented in FIG. 6, all of the objects are registered, and objects not to be moved are represented by using a mark representing no information. The object movement control unit 13 notifies the management apparatus 3 of the information on the object stored in the movement source OSD 40 together with the priority.

Thereafter, the object movement control unit 13 receives, from the management apparatus 3, the OSD-ID of the movement source OSD 40, the object ID of the object to be moved, and the OSD-ID of the movement destination OSD 40 together with the instruction to execute the movement of the object. The object movement control unit 13 instructs the object control unit 41 of the movement source OSD 40 to move the object to the movement destination OSD 40. The object movement control unit 13 registers, in the object movement plan management table 143, the movement destination OSD-ID, the movement destination bucket ID, the movement destination PG-ID, and the movement time point of the moved object. The object moved by the capacity securing movement processing is referred to as a “capacity securing movement object”.

Thereafter, the object movement control unit 13 checks a situation of the movement processing of the object with respect to the movement source OSD 40. When the object movement processing is completed, the object movement control unit 13 notifies the management apparatus 3 of the completion of the movement processing and ends the capacity securing movement processing for the object.

In a case where rebalancing occurs due to an increase in capacity, the object movement control unit 13 receives the instruction to execute the rebalancing from the management apparatus 3. The object movement control unit 13 executes the rebalancing. In a case where the capacity securing movement object is a rebalancing target, the object movement control unit 13 specifies a movement destination from the object movement plan management table 143, acquires an actual object from the movement destination OSD 40, and executes the rebalancing. After the execution of the rebalancing is completed, the object movement control unit 13 deletes information on the movement destination of the moved capacity securing movement object in the object movement plan management table 143 in a case where the capacity securing movement object is moved by the rebalancing.

In a case where the rebalancing ends or the object is deleted by the request control unit 11, the object movement control unit 13 receives the transmission request for the information on the capacity securing movement object and the movement source OSD 40 from the management apparatus 3. The object movement control unit 13 sequentially extracts the capacity securing movement objects with reference to the object movement plan management table 143. In this case, the object movement control unit 13 decides an extraction order of the capacity securing movement objects in consideration of an influence on a resource amount due to return. For example, the object movement control unit 13 preferentially extracts a capacity securing movement object having a large object size. The object movement control unit 13 acquires information on the movement source OSD 40 and the movement destination OSD 40 of the extracted capacity securing movement object from the object movement plan management table 143. The object movement control unit 13 transmits the information on the extracted capacity securing movement object and the information on the movement destination OSD 40 and the movement source OSD 40 to the management apparatus 3.

Thereafter, in a case where the extracted capacity securing movement object is returned to a storage state before the movement, the object movement control unit 13 receives, from the management apparatus 3, an instruction to return the capacity securing movement object to the movement source OSD 40. The object movement control unit 13 instructs the movement destination OSD 40 to return the extracted capacity securing movement object to the movement source OSD 40. The object movement control unit 13 deletes the information on the movement of the returned capacity securing movement object in the object movement plan management table 143. The object movement control unit 13 corresponds to an example of a “priority deciding unit”.

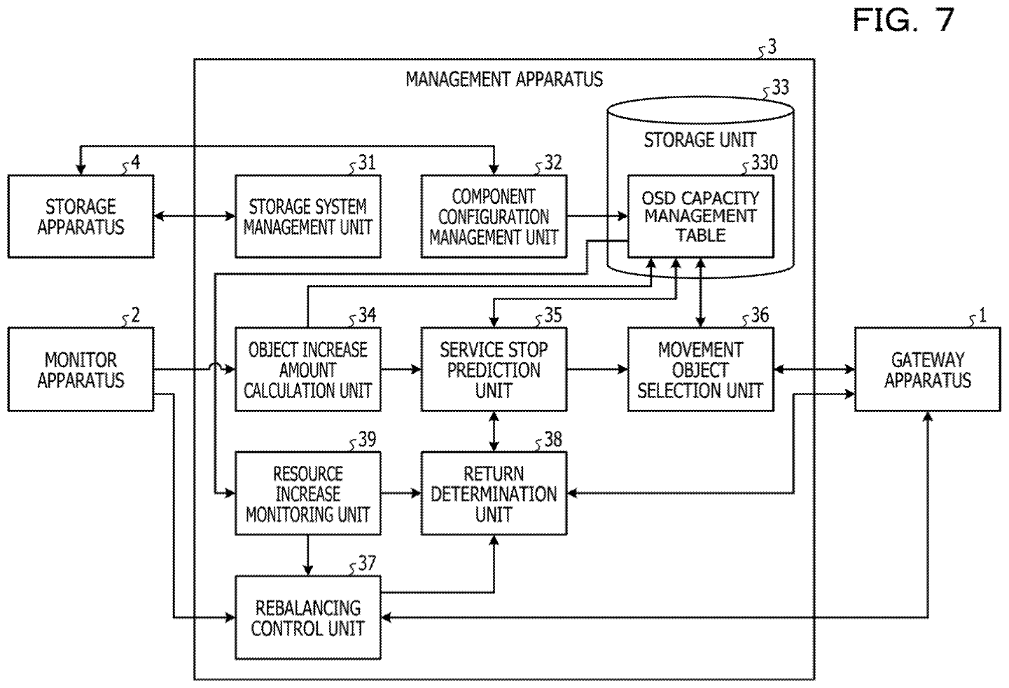

Next, the management apparatus 3 will be described in detail with reference to FIG. 7. FIG. 7 is a block diagram of the management apparatus. As represented in FIG. 7, the management apparatus 3 includes a storage system management unit 31, a component configuration management unit 32, a storage unit 33, an object increase amount calculation unit 34, a service stop prediction unit 35, a movement object selection unit 36, a rebalancing control unit 37, a return determination unit 38, and a resource increase monitoring unit 39.

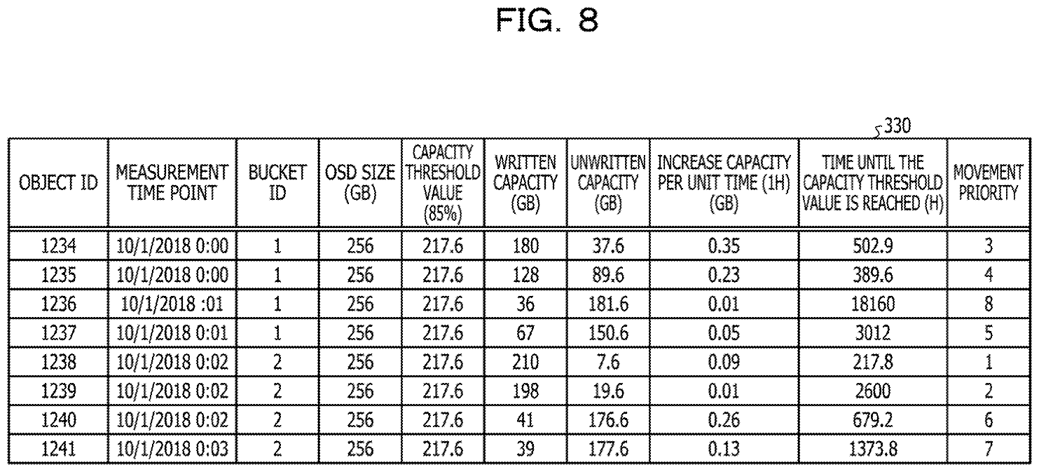

The storage unit 33 is a storage medium such as the hard disk. The storage unit 33 includes an OSD capacity management table 330 as represented in FIG. 7. FIG. 8 is a diagram representing an example of an OSD capacity management table.

The OSD capacity management table 330 stores information on each object in association with the object ID. For example, measurement time point, bucket ID, OSD size, capacity threshold value, written capacity, unwritten capacity, increase capacity per unit time, time until the capacity threshold value is reached, and movement priority, and the like are registered in the OSD capacity management table 330.

The measurement time point represents a timing at which the information registered in the OSD capacity management table 330 is measured. In the present example, the data is updated every one hour. The capacity threshold value is a threshold value for determining that the writing becomes difficult in a case where an object preservation capacity, which is the amount of data written to the OSD 40, becomes equal to or larger than the capacity threshold value. In the present example, 85% of a total capacity is set as the capacity threshold value. The written capacity is the object preservation capacity which is the amount of data written to the OSD 40. The unwritten capacity is a free capacity of the OSD 40. The increase capacity per unit time is a value calculated by the object increase amount calculation unit 34. The time until the capacity threshold value is reached is a value calculated by the service stop prediction unit 35. The movement priority is information representing an order of the OSD 40 with the stored object as a target to be moved. In the present example, the movement priority is decided to be higher as the time until the capacity threshold value is reached is shorter.

Returning to FIG. 7, the description is continued. The storage system management unit 31 generates a duster in the storage apparatus 4 or the like in response to an instruction from the administrator.

The component configuration management unit 32 constructs and manages the OSD 40 in the storage apparatus 4 in response to the instruction from the administrator. The component configuration management unit 32 acquires the OSD-ID, the bucket ID, the OSD size, and the capacity threshold value of each OSD 40 from the monitor apparatus 2. The component configuration management unit 32 registers the acquired information in the OSD capacity management table 330.

The object increase amount calculation unit 34 periodically acquires, from the monitor apparatus 2, the object preservation capacity which is the amount of data stored in each OSD 40 included in the storage apparatus 4. Next, the object increase amount calculation unit 34 acquires a previous object preservation capacity from the OSD capacity management table 330. Then, the object increase amount calculation unit 34 calculates the increase capacity per unit time of each OSD 40. For example, the object increase amount calculation unit 34 divides the increase in the object preservation capacity by a monitoring time during which the increase therein occurs to calculate the increase capacity per unit time, as indicated by the following Equation (1).

Increase capacity per unit time=“increase in object preservation capacity”/“monitoring time during increase” (1)

Thereafter, the object increase amount calculation unit 34 registers the measurement time point, the written capacity, the unwritten capacity, and the increase capacity per unit time in the OSD capacity management table 330. The object increase amount calculation unit 34 requests the service stop prediction unit 35 to calculate a capacity threshold value reaching time.

The service stop prediction unit 35 periodically receives the request for the calculation of the capacity threshold value reaching time from the object increase amount calculation unit 34. The service stop prediction unit 35 calculates the capacity threshold value reaching time using the information registered in the OSD capacity management table 330. For example, the service stop prediction unit 35 divides the unwritten capacity by the increased capacity per unit time to calculate the capacity threshold value reaching time, as indicated by the following Equation (2).

Capacity threshold value reaching time=“unwritten capacity”/“increase capacity per unit time” (2)

Thereafter, the service stop prediction unit 35 registers the calculated capacity threshold value reaching time of each OSD 40 in the OSD capacity management table 330. The service stop prediction unit 35 notifies the movement object selection unit 36 of update of the capacity threshold value reaching time.

The service stop prediction unit 35 receives, from the return determination unit 38, the request for calculating the following capacity threshold value reaching time after the rebalancing is executed and after the object is deleted. One is a request for calculating a capacity threshold value reaching time of the movement destination OSD 40 in a case where the capacity securing movement object extracted as a return determination target is maintained in a current state. Another is a request for calculating a capacity threshold value reaching time of the movement source OSD 40 in a case where the capacity securing movement object extracted as the return determination target is returned. At this time, the service stop prediction unit 35 also acquires, from the return determination unit 38, an object size of the capacity securing movement object extracted as the return determination target.

Next, the service stop prediction unit 35 acquires, from the OSD capacity management table 330, unwritten capacities and increase capacities per unit time of the movement source OSD 40 and the movement destination OSD 40. The service stop prediction unit 35 divides a current unwritten capacity by the increase capacity per unit time for the movement destination OSD 40 to calculate the capacity threshold value reaching time of the movement destination OSD 40 in the case where the current state is maintained. The service stop prediction unit 35 divides a value obtained by subtracting the object size from the current unwritten capacity by the increase capacity per unit time for the movement source OSD 40 to calculate the capacity threshold value reaching time of the movement source OSD 40 in a case where the return is made. Thereafter, the service stop prediction unit 35 notifies the return determination unit 38 of the capacity threshold value reaching time of the movement destination OSD 40 in the case where the current state is maintained and the capacity threshold value reaching time of the movement source OSD 40 in the case where the return is made.

The movement object selection unit 36 receives the notification of the update of the capacity threshold value reaching time from the service stop prediction unit 35. The movement object selection unit 36 has a determination target period in advance for determining whether or not the writing to each OSD is difficult to be performed within the period. The movement object selection unit 36 acquires the capacity threshold value reaching time of each OSD 40 from the OSD capacity management table 330. The movement object selection unit 36 assigns the movement priority to each OSD 40 in ascending order of the capacity threshold value reaching time and registers the order in the OSD capacity management table 330.

The movement object selection unit 36 determines whether or not there is an OSD in which the capacity threshold value reaching time is less than the determination target period. When there is no OSD whose capacity threshold value reaching time is less than the determination target period, the movement object selection unit 36 ends movement determination processing of the object in the capacity securing movement processing.

On the contrary, in a case where there are OSDs 40 whose capacity threshold value reaching time are less than the determination target period, the movement object selection unit 36 selects a movement source OSD 40 which is the movement source of the object movement in descending order of the movement priority registered in the OSD capacity management table 330 from among the OSDs 40. The movement object selection unit 36 selects an OSD 40 having the longest capacity threshold value reaching time as the movement destination OSD 40. In the present example, the movement source OSD 40 and the movement destination OSD 40 are decided by using the capacity threshold value reaching time. However, the movement object selection unit 36 may decide the movement source OSD 40 and the movement destination OSD 40 by using other information. For example, the movement object selection unit 36 may decide the movement source OSD 40 and the movement destination OSD in consideration of the unwritten capacity of each OSD 40 in addition to the capacity threshold value reaching time.

Next, the movement object selection unit 36 transmits the instruction to decide the priority of the object to the object movement control unit 13 of the gateway apparatus 1 together with the information on the OSD 40 which is the movement source. Thereafter, the movement object selection unit 36 receives the information on the priority assigned to each object from the object movement control unit 13 of the gateway apparatus 1 together with the object ID of the object stored in the movement source OSD 40.

The movement object selection unit 36 simulates the capacity threshold value reaching time for each OSD 40 in a case where the object is moved from the movement source OSD 40 to the movement destination OSD 40. For example, the movement object selection unit 36 subtracts the object size of the object to be moved from the unwritten capacity of the movement destination OSD 40 and divides the subtracted size by the increase capacity to calculate the capacity threshold value reaching time of the movement destination OSD 40 after the object movement. The movement object selection unit 36 adds the object size of the object to be moved to the unwritten capacity of the movement source OSD 40 and divides the added size by the increase capacity to calculate the capacity threshold value reaching time of the movement source OSD 40 after the object movement. The movement object selection unit 36 executes the calculations in a case where one or more of the objects are combined in descending order of priority. The movement object selection unit 36 extracts a combination of the object and the movement destination OSD 40 having the longest combination of the capacity threshold value reaching times of the movement source and movement destination OSDs 40, from the calculation result. The movement object selection unit 36 transmits the OSD-ID of the movement source OSD 40, the object ID of the object to be moved, and the OSD-ID of the movement destination OSD 40 to the object movement control unit 13 of the gateway apparatus 1 together with the instruction to execute the movement of the object.

Thereafter, the movement object selection unit 36 checks an execution situation of the capacity securing movement processing with respect to the object movement control unit 13 of the gateway apparatus 1. When the movement object selection unit 36 checks the completion of the capacity securing movement processing, the management apparatus 3 ends the capacity securing movement processing. The movement object selection unit 36 corresponds to an example of a “movement control unit”. The object to be moved, which is decided to be moved by the movement object selection unit 36, corresponds to an example of “specific data”.

In the present example, the movement object selection unit 36 selects the OSD 40 having the longest capacity threshold value reaching time as the movement destination OSD 40, but may select the plurality of OSDs 40 as candidates for the movement destination OSD 40. In this case, the movement object selection unit 36 performs a simulation to decide the combination of the object to be moved in the movement source OSD 40 and the movement destination OSD 40 from the capacity threshold value reaching time or the like.

The resource increase monitoring unit 39 monitors an increase in resource of the storage pool due to deletion of the object, addition of the storage apparatus 4, or the like, with reference to the OSD capacity management table 330. The resource increase monitoring unit 39 determines whether or not the increase in capacity due to addition of the storage apparatus 4 or the like occurs in the storage pool. In a case where the increase in capacity occurs, the resource increase monitoring unit 39 instructs the rebalancing control unit 37 to execute the rebalancing.

When the increase in capacity does not occur, the resource increase monitoring unit 39 determines whether or not the deletion of the object occurs. In a case where the deletion of the object occurs (Yes in step S403), the resource increase monitoring unit 39 requests the return determination unit 38 to perform the return determination for the capacity securing movement object.

The rebalancing control unit 37 receives an instruction to execute the rebalancing from the resource increase monitoring unit 39. The rebalancing control unit 37 acquires information on the added OSD 40 from the monitor apparatus 2 to decide the movement of the object and causes the object movement control unit 13 of the gateway apparatus 1 to execute the rebalancing.

The rebalancing control unit 37 receives the notification of the completion of the rebalancing from the object movement control unit 13 of the gateway apparatus 1. The rebalancing control unit 37 requests the return determination unit 38 to perform the return determination for the capacity securing movement object.

After the rebalancing is completed, the return determination unit 38 receives the request for the return determination for the capacity securing movement object from the rebalancing control unit 37. After the deletion of the object occurs, the return determination unit 38 receives the request for the return determination for the capacity securing movement object from the resource increase monitoring unit 39.

The return determination unit 38 instructs the object movement control unit 13 of the gateway apparatus 1 to transmit the information on the capacity securing movement object and the movement source OSD 40 of the capacity securing movement object. Thereafter, the return determination unit 38 receives the object ID of the extracted capacity securing movement object and the object IDs of the movement source OSD 40 and the movement destination OSD 40 from the object movement control unit 13 of the gateway apparatus 1. The return determination unit 38 transmits the information on the movement destination OSD 40 and the movement source OSD 40 of the extracted capacity securing movement object, and requests the service stop prediction unit 35 to calculate the capacity threshold value reaching time.

Thereafter, the return determination unit 38 acquires, from the service stop prediction unit 35, the capacity threshold value reaching time of the movement destination OSD 40 in a case where the extracted capacity securing movement object is maintained in the current state and the capacity threshold value reaching time of the movement source OSD 40 in a case where the extracted capacity securing movement object is returned. In a case where the capacity threshold value reaching time of the movement destination OSD 40 in the case where the current state is maintained is larger than the capacity threshold value reaching time of the movement source OSD 40 in the case where the return is made, the return determination unit 38 determines to maintain the extracted capacity securing movement object in the current state. On the contrary, in a case where the capacity threshold value reaching time of the movement destination OSD 40 in the case where the current state is maintained is equal to or less than the capacity threshold value reaching time of the movement source OSD 40 in the case where the return is made, the return determination unit 38 determines to return the extracted capacity securing movement object. In the case where the return determination unit 38 determines to return the extracted capacity securing movement object, the return determination unit 38 instructs the object movement control unit 13 of the gateway apparatus 1 to return the extracted capacity securing movement object to the movement source OSD 40.

Next, an operation of the OSD 40 will be described. In the case of the capacity securing movement processing, the movement source OSD 40 receives a command of the movement the object from the gateway apparatus 1. The movement source OSD 40 transmits the designated object to the movement destination OSD 40 together with a writing command.

The movement destination OSD 40 receives the writing command from the movement source OSD 40, writes the received object into a bucket of a PG of the movement destination OSD 40, and notifies the movement source OSD of writing completion.

When the notification of the writing completion is received, the movement source OSD 40 records the information on the object ID and the movement destination OSD 40 of the capacity securing movement object to a position indicated by the hash information of the capacity securing movement object. The information on the object ID and the movement destination OSD 40 of the capacity securing movement object recorded at the position indicated by the hash value of the capacity securing movement object may be referred to as a “symbolic link”.

Thereafter, the movement source OSD 40 deletes the capacity securing movement object in which the symbolic link is recorded, from the object storage unit 42. The movement source OSD 40 notifies the object movement control unit 13 of the gateway apparatus 1 of the completion of the movement processing.

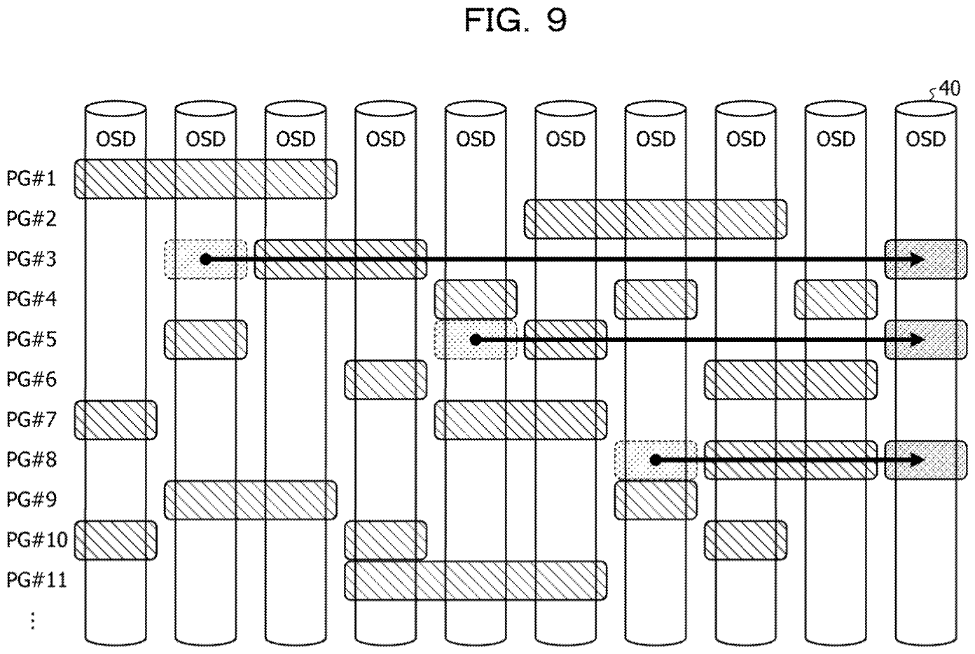

When the instruction for rebalancing is received from the object movement control unit 13 of the gateway apparatus 1, the OSD 40 executes the rebalancing. FIG. 9 is a diagram representing reconstruction of PGs by the rebalancing. FIG. 9 represents a state where an OSD 40 at the right end facing a paper surface is added. When the OSD 40 increases due to the addition of the storage apparatus 4 or the like, the PGs are reconstructed. Accordingly, the PGs are assigned to the newly added OSD 40. The OSD 40 having an object belonging to the PG assigned to the newly added OSD 40 moves the object as indicated by an arrow in FIG. 9 by the rebalancing.

At this time, the OSD 40 determines whether or not there is the object in which the symbolic link is recorded in a rebalancing target. In a case where there is the object in which the symbolic link is recorded in the rebalancing target, the OSD 40 notifies the object movement control unit 13 of the information on the movement destination OSD 40 indicated by the symbolic link. The OSD 40 notifies the object movement control unit 13 of the information on the movement destination OSD 40 due to the rebalancing of the object to cause the object movement control unit 13 to execute the movement due to the rebalancing of the object. After the rebalancing ends, the OSD 40 deletes the symbolic link of the object, which is the rebalancing target, in which the symbolic link is recorded.

In a case where the capacity securing movement object is returned, the movement source OSD 40 receives the writing command from the movement destination OSD 40 together with the capacity securing movement object. The movement source OSD 40 returns the capacity securing movement object with the storage state before the movement for the writing to the position indicated by the hash value of the capacity securing movement object and deletes the symbolic link recorded at the position.

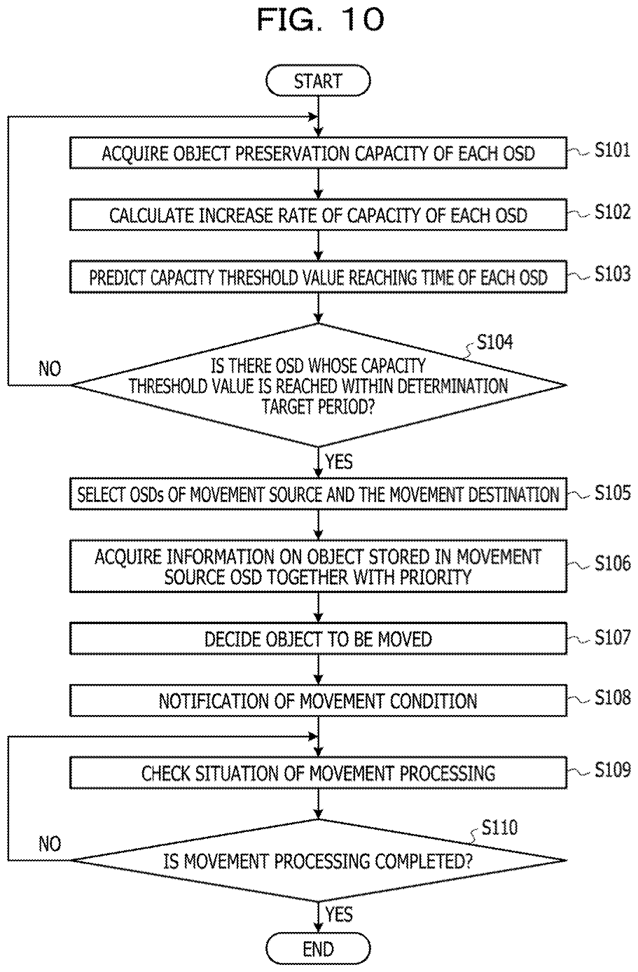

Next, a flow of an operation of the capacity securing movement processing of the management apparatus 3 according to the present example will be described with reference to FIG. 10. FIG. 10 is a flowchart of the operation of capacity securing movement processing performed by the management apparatus according to Example 1.

The object increase amount calculation unit 34 acquires the object preservation capacity of each OSD 40 from the monitor apparatus 2 (step S101).

Next, the object increase amount calculation unit 34 acquires the object preservation capacity of each OSD 40 at the time of the last measurement from the OSD capacity management table 330. The object increase amount calculation unit 34 calculates an increase amount of the capacity of each OSD 40 (step S102). Thereafter, the object increase amount calculation unit 34 registers the measurement time point and the written capacity, unwritten capacity, and increase amount of the capacity of each OSD 40 in the OSD capacity management table 330.

The service stop prediction unit 35 acquires the unwritten capacity and the increase amount of the capacity of each OSD 40 from the OSD capacity management table 330. The service stop prediction unit 35 predicts the capacity threshold value reaching time of each OSD 40 using the unwritten capacity and the increase amount of the capacity (step S103). Thereafter, the service stop prediction unit 35 registers the calculated capacity threshold value reaching time of each OSD 40 in the OSD capacity management table 330.

The movement object selection unit 36 acquires the capacity threshold value reaching time of each OSD 40 from the OSD capacity management table 330. The movement object selection unit 36 decides the movement priority of each OSD 40 in ascending order of the capacity threshold value reaching time and registers the decided priority in the OSD capacity management table 330. Next, the movement object selection unit 36 determines whether or not there is an OSD 40 whose capacity reaches the capacity threshold value within a predetermined determination target period (step S104). In a case where there is no OSD 40 whose capacity reaches the capacity threshold value within the determination target period (No in step S104), the capacity securing movement processing returns to step S101.

On the contrary, in a case where there is the OSD 40 whose capacity reaches the capacity threshold value within the determination target period (Yes in step S104), the movement object selection unit 36 selects the movement source OSD 40 and the movement destination OSD 40 based on the capacity threshold value reaching time (step S105). For example, the movement object selection unit 36 selects an OSD 40 having the shortest capacity threshold value reaching time as the movement source OSD 40 and selects an OSD 40 having the longest capacity threshold value reaching time as the movement destination OSD 40.

The movement object selection unit 36 transmits the instruction to decide the priority of the object to the object movement control unit 13 of the gateway apparatus 1, together with the information on the movement source OSD 40. Thereafter, the movement object selection unit 36 acquires the information on the object stored in the movement source OSD 40 from the object movement control unit 13 of the gateway apparatus 1, together with the priority (step S106).

Next, the movement object selection unit 36 performs a simulation in a case where an object to be moved is selected according to the priority to obtain the capacity threshold value reaching times of the movement source OSD and the movement destination OSD 40 in each case. The movement object selection unit 36 decides a combination of objects having the longest capacity threshold value reaching time as the object to be moved (step S107).

Next, the movement object selection unit 36 notifies the object movement control unit 13 of the gateway apparatus 1 of a movement condition including the information on the movement source OSD 40, the object to be moved, and the movement destination OSD 40 (step S108).

Thereafter, the movement object selection unit 36 checks the situation of the movement processing with respect to the object movement control unit 13 of the gateway apparatus 1 (step S109).

The movement object selection unit 36 determines whether or not the movement processing is completed (step S110). In a case where the movement processing is not completed (No in step S110), the movement object selection unit 36 returns to step S109 and continues to check the situation of the movement processing.

On the contrary, in a case where the movement object selection unit 36 determines that the movement processing is completed (Yes in step S110), the management apparatus 3 ends the capacity securing movement processing.

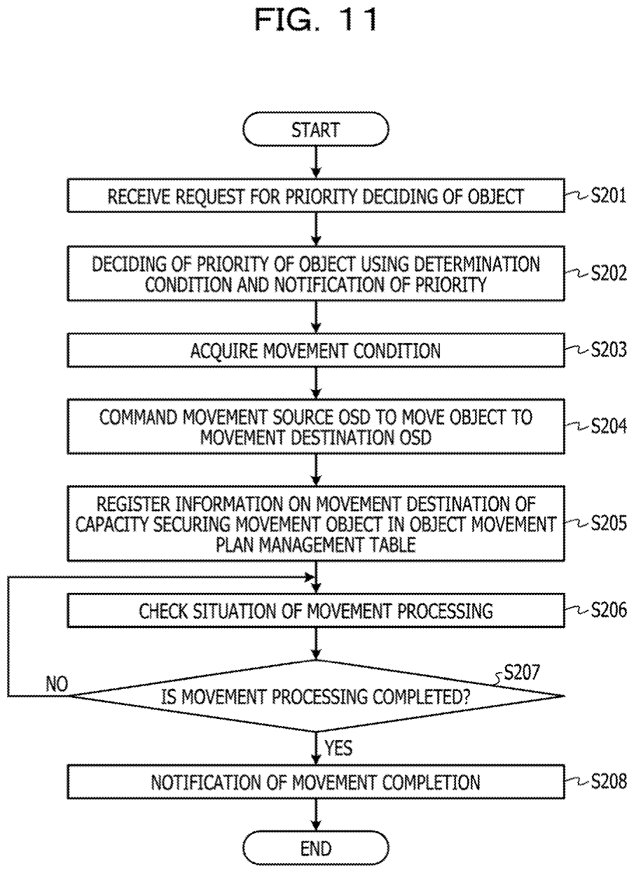

Next, a flow of an operation of the capacity securing movement processing of the gateway apparatus 1 according to the present example will be described with reference to FIG. 11. FIG. 11 is a flowchart of the operation of the capacity securing movement processing performed by the gateway apparatus according to Example 1.

The object movement control unit 13 receives the request for the priority deciding of the object from the movement object selection unit 36 of the management apparatus 3 together with the information on the movement source OSD 40 (step S201).

Next, the object movement control unit 13 decides the priority of the movement of each object stored in the movement source OSD 40 using the first to fourth conditions which are the determination conditions of the priority deciding and notifies the movement object selection unit 36 of the management apparatus 3 of the decided priority (step S202).

The object movement control unit 13 acquires the movement condition including the information on the movement source OSD 40, the object to be moved, and the movement destination OSD 40 from the movement object selection unit 36 of the management apparatus 3 (step S203).

Next, the object movement control unit 13 commands the movement source OSD 40 to move the object to the movement destination OSD (step S204).

The object movement control unit 13 registers the information on the movement destination of the capacity securing movement object in the object movement plan management table 143 (step S205).

Thereafter, the object movement control unit 13 checks the situation of the movement processing with respect to the movement source OSD (step S206).

The object movement control unit 13 determines whether or not the movement processing is completed (step S207). In a case where the movement processing is not completed (No in step S207), the object movement control unit 13 returns to step S206 and continues to check the situation of the movement processing.

On the contrary, in a case where the movement processing is completed (Yes in step S207), the object movement control unit 13 notifies the movement object selection unit 36 of the management apparatus 3 of the completion of the movement (step S208).

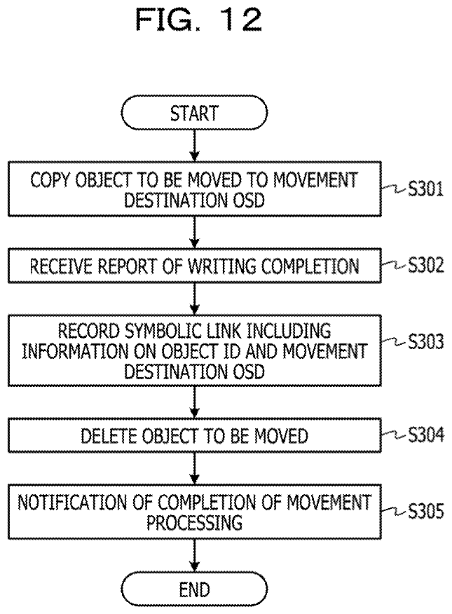

Next, a flow of an operation of the capacity securing movement processing of the OSD 40 according to the present example will be described with reference to FIG. 12. FIG. 12 is a flowchart of the operation of the capacity securing movement processing performed by the OSD according to Example 1.

The movement source OSD 40 transmits the object to be moved to the movement destination OSD 40 and commands the writing of the data to copy the object to be moved to the movement destination OSD 40 (step S301).

Thereafter, the movement source OSD 40 receives a report of the writing completion from the movement destination OSD 40 (step S302).

Next, the movement source OSD 40 records a symbolic link including the information on the object ID and the movement destination OSD 40 of the object moved to a location indicated by the hash information obtained from the moved object (step S303).

The movement source OSD 40 deletes the object to be moved from the object storage unit 42 of the movement source OSD 40 (step S304).

Thereafter, the movement source OSD 40 notifies the object movement control unit 13 of the gateway apparatus 1 of the completion of the movement processing (step S305).

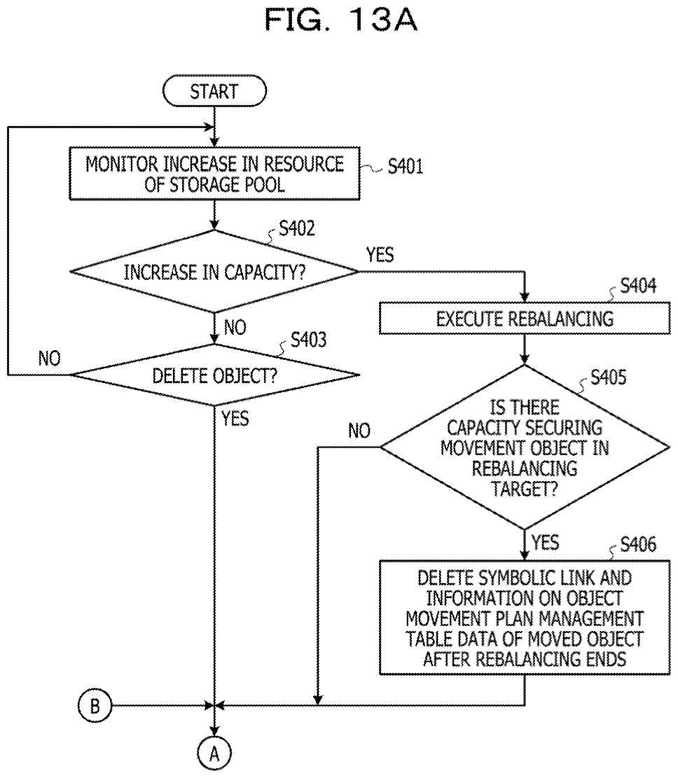

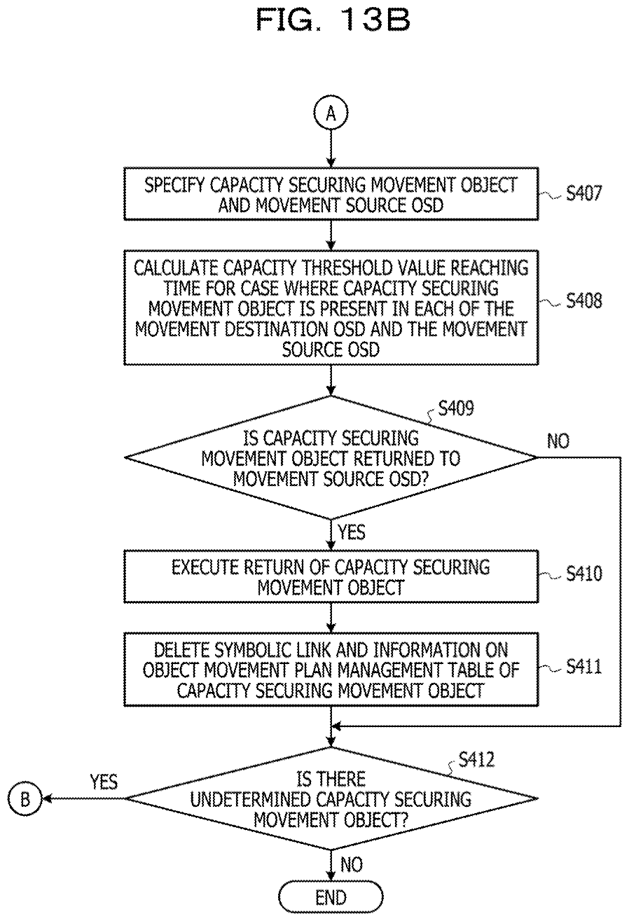

Next, a flow of return processing of the capacity securing movement object will be described with reference to FIGS. 13A and 13B. FIGS. 13A and 13B are a flowchart of the return processing of the object performed by the object storage apparatus according to Example 1.

The component configuration management unit 32 acquires the information such as the addition of the storage apparatus 4 and the OSD 40 from the component monitoring unit 21 of the monitor apparatus 2, and registers the acquired information in the OSD capacity management table 330. The object increase amount calculation unit 34 periodically acquires the written capacity of the object of each OSD 40 from the component monitoring unit 21 of the monitor apparatus 2, and registers the written capacity and the unwritten capacity of each OSD 40 in the OSD capacity management table 330. The resource increase monitoring unit 39 monitors the increase in resource of the storage pool due to the deletion of the object, the addition of the storage apparatus 4, or the like with reference to the OSD capacity management table 330 (step S401).

The resource increase monitoring unit 39 determines whether or not the increase in capacity due to the addition of the storage apparatus 4 or the like occurs in the storage pool (step S402).

In a case where the increase in capacity does not occur (No in step S402), the resource increase monitoring unit 39 determines whether or not the deletion of the object occurs (step S403).

In a case where the deletion of the object does not occur (No in step S403), the resource increase monitoring unit 39 returns to step S401. On the contrary, in a case where the deletion of the object occurs (Yes in step S403), the resource increase monitoring unit 39 requests the return determination unit 38 to perform the return determination for the capacity securing movement object. The return processing of the capacity securing movement object proceeds to step S407.

On the other hand, in a case where the increase in capacity occurs (Yes in step S402), the resource increase monitoring unit 39 notifies the rebalancing control unit 37 of the increase in capacity. The rebalancing control unit 37 receives the notification of the increase in capacity from the resource increase monitoring unit 39. The rebalancing control unit 37 acquires the information on the increased OSD 40 from the monitor apparatus 2 and instructs the object movement control unit 13 of the gateway apparatus 1 to move the object by the rebalancing. The object movement control unit 13 receives the instruction to execute the rebalancing from the rebalancing control unit 37. The object movement control unit 13 commands the OSD 40 to execute the rebalancing and moves the object to execute the rebalancing (step S404).

The object movement control unit 13 and the OSD 40 determine whether or not there is a capacity securing movement object in the rebalancing target (step S405). In a case where there is no capacity securing movement object in the rebalancing target (No in step S405), the object movement control unit 13 notifies the rebalancing control unit 37 of the completion of the rebalancing after the rebalancing completion. When the notification of the rebalancing completion is received, the rebalancing control unit 37 requests the return determination unit 38 to perform the return determination for the capacity securing movement object. The return processing of the capacity securing movement object proceeds to step S407.

On the contrary, in a case where there is the capacity securing movement object in the rebalancing target (Yes in step S405), the object movement control unit 13 and the OSD 40 execute the following processing after the rebalancing ends. The OSD 40 deletes the symbolic link of the capacity securing movement object moved by the rebalancing. The object movement control unit 13 deletes the information on the movement of the capacity securing movement object moved by the rebalancing in the object movement plan management table 143 (step S406). Thereafter, the object movement control unit 13 notifies the rebalancing control unit 37 of the rebalancing completion. When the notification of the rebalancing completion is received, the rebalancing control unit 37 requests the return determination unit 38 to perform the return determination for the capacity securing movement object. The return processing of the capacity securing movement object proceeds to step S407.

The return determination unit 38 receives the request for the return determination for the capacity securing movement object from the resource increase monitoring unit 39 or the rebalancing control unit 37. The return determination unit 38 requests the information on the capacity securing movement object and the movement source OSD 40 from the object movement control unit 13 of the gateway apparatus 1. The object movement control unit 13 specifies one of the capacity securing movement object or the movement source OSD 40 with reference to the object movement plan management table 143 (step S407). The object movement control unit 13 transmits the specified information on the capacity securing movement object or the movement source OSD 40 to the return determination unit 38 of the management apparatus 3.

The return determination unit 38 acquires the information on the capacity securing movement object and the movement source OSD 40 from the object movement control unit 13 of the gateway apparatus 1. The return determination unit 38 requests the service stop prediction unit 35 to calculate each of the capacity threshold value reaching times for a case where the capacity securing movement object is present in each of the movement destination OSD 40 and the movement source OSD 40. The service stop prediction unit 35 calculates each of the capacity threshold value reaching times for the case where the capacity securing movement object is present in each of the movement destination OSD 40 and the movement source OSD 40 using the OSD capacity management table 330, in response to the request from the return determination unit 38 (step S408). Thereafter, the service stop prediction unit 35 notifies the return determination unit 38 of the calculated capacity threshold value reaching times.

The return determination unit 38 determines whether or not to return the capacity securing movement object to the movement source OSD 40 using each of the capacity threshold value reaching times for the case where the capacity securing movement object is in each of the movement destination OSD and the movement source OSD 40 (step S409). In a case where the return of the capacity securing movement object to the movement source OSD 40 is not performed (No in step S409), the return determination unit 38 proceeds to step S412.

On the contrary, in a case where the capacity securing movement object is returned to the movement source OSD 40 (Yes in step S409), the return determination unit 38 instructs the object movement control unit 13 of the storage apparatus 4 to return the capacity securing movement object to the movement source OSD 40. The object movement control unit 13 receives the instruction from the return determination unit 38 and instructs the movement destination OSD 40 of the capacity securing movement object to be returned to move the object to the movement source OSD 40 to execute the return of the capacity securing movement object (step S410).

The movement source OSD 40 to which the capacity securing movement object is returned deletes the symbolic link of the capacity securing movement object. The object movement control unit 13 deletes the information on the movement of the returned capacity securing movement object in the object movement plan management table 143 (step S411).

Thereafter, the return determination unit 38 inquires of the object movement control unit 13 of the storage apparatus 4 to determine whether or not there is an undetermined capacity securing movement object (step S412). In a case where there is the undetermined capacity securing movement object (Yes in step S412), the return determination unit 38 returns to step S407. On the contrary, in a case where there is no undetermined capacity securing movement object (No in step S412), the return determination unit 38 ends the return determination processing of the capacity securing movement object.

(Hardware Configuration)

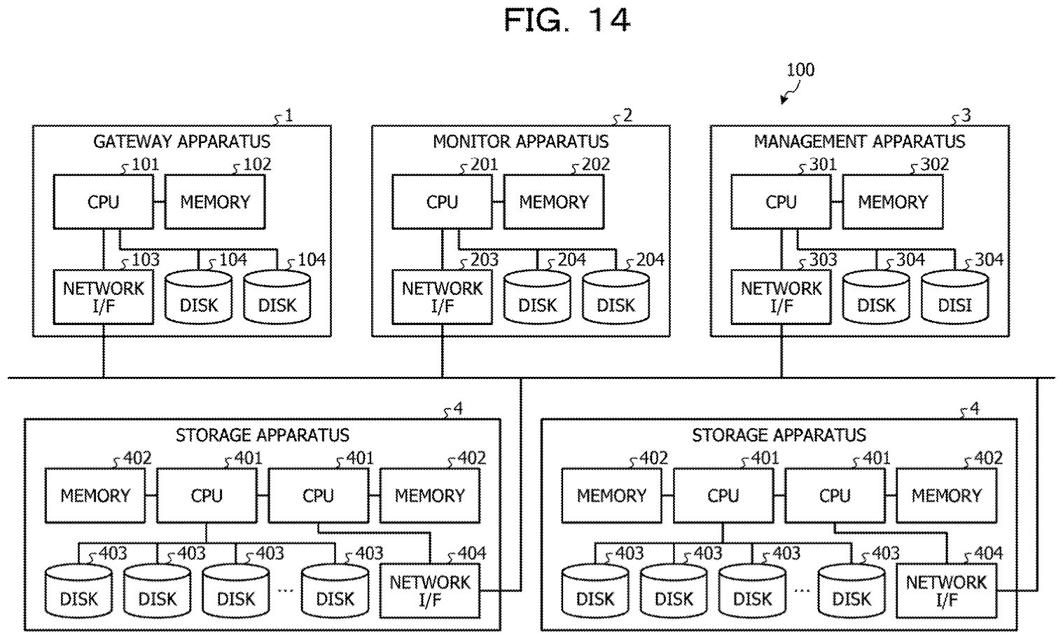

A hardware configuration of each apparatus will be described with reference to FIG. 14. FIG. 14 is a hardware configuration diagram of the object storage system.

The gateway apparatus 1 includes, for example, a central processing unit (CPU) 101, a memory 102, a network interface (I/F) 103, and a disk 104. The network interface 103 is an interface for communicating with the monitor apparatus 2, the management apparatus 3, and the storage apparatus 4.

The disk 104 realizes the function of the storage unit 14 illustrated in FIG. 3. The disk 104 stores various programs including a program for realizing the functions of the request control unit 11, the access information management unit 12, and the object movement control unit 13 illustrated in FIG. 3.

The CPU 101 reads the various programs stored in the disk 104, develops the programs in the memory 102, and executes the programs to realize the functions of the request control unit 11, the access information management unit 12, and the object movement control unit 13 illustrated in FIG. 3.

The monitor apparatus 2 includes, for example, a CPU 201, a memory 202, a network interface 203, and a disk 204. The network interface 203 is an interface for communicating with the gateway apparatus 1, the management apparatus 3, and the storage apparatus 4.

The disk 204 stores various programs including a program for realizing the functions of the component monitoring unit 21 and the resource use amount monitoring unit 22 illustrated in FIG. 1.

The CPU 201 reads various programs stored in the disk 204, develops the programs in the memory 202, and executes the programs to realize the functions of the component monitoring unit 21 and the resource use amount monitoring unit 22 illustrated in FIG. 1.

The management apparatus 3 includes, for example, a CPU 301, a memory 302, a network interface 303, and a disk 304. The network interface 303 is an interface for communicating with the gateway apparatus 1, the monitor apparatus 2, and the storage apparatus 4.

The disk 304 realizes the function of the storage unit 33 illustrated in FIG. 7. The disk 304 stores various programs. The various programs include a program for realizing the functions of the storage system management unit 31, the component configuration management unit 32, the object increase amount calculation unit 34, the service stop prediction unit 35, and the movement object selection unit 36 illustrated in FIG. 7. The various programs include a program for realizing the functions of the rebalancing control unit 37, the return determination unit 38, and the resource increase monitoring unit 39 illustrated in FIG. 7.

The CPU 301 reads various programs stored in the disk 304, develops the programs in the memory 302, and executes the programs to realize the functions of the component configuration management unit 32, the object increase amount calculation unit 34, the service stop prediction unit 35, and the movement object selection unit 36 illustrated in FIG. 1. The CPU 301 realizes the functions of the rebalancing control unit 37, the return determination unit 38, and the resource increase monitoring unit 39 illustrated in FIG. 7.

The storage apparatus 4 includes a CPU 401, a memory 402, a disk 403, and a network interface 404. The network interface 404 is an interface for communicating with the gateway apparatus 1, the monitor apparatus 2, and the management apparatus 3.

The disk 403 realizes the function of the object storage unit 42 illustrated in FIG. 1. The CPU 401 and the memory 402 realize the function of the object control unit 41 illustrated in FIG. 1. For example, the CPU 401, the memory 402, and the disk 403 realize the function of the OSD 40 illustrated in FIG. 1.

As described above, in the case where the free capacity of the OSD is reduced, the object storage system according to the present example moves the object stored in the OSD to the other OSD and records the symbolic link to the original storage position. Accordingly, it is possible to move the object while the access to the object using the hash value is secured and thus to avoid the difficulty in the writing to the OSD. Therefore, it is possible to avoid the state of the storage service stop that makes the writing to the object difficult and thus to maintain the continuity of the storage service. The access to the arrangement destination uniquely decided at the time of data storage is not changed. Therefore, it is unnecessary to change the mechanism itself in which the arrangement destination is uniquely decided by the hash value and it is possible to access to the movement destination.

The OSD of the movement source is decided according to the priority based on the capacity threshold value reaching time or the like, and thus it is possible to avoid the state where the writing becomes difficult certainly. The priority of the object to be moved is decided by the preservation period, the preservation date and time, the access frequency, and the object size. Therefore, it is possible to secure the free capacity as much as possible while the influence of the movement of the object is suppressed and thus to efficiently maintain the continuity of the storage service. The object to be moved is decided based on the capacity threshold value reaching time due to the movement of the object, and thus it is possible to efficiently maintain the continuity of the storage service.

### Example 2

Next, Example 2 will be described. An object storage system according to the present example is different from that in Example 1 in that the object storage system considers storage to another OSD in a case where the capacity securing movement object is not returned in the return determination. The object storage system according to the present example is also represented in FIG. 1. The gateway apparatus 1 and the management apparatus 3 according to the present example are also represented in FIGS. 3 and 7. In the following description, the description for the operation of each unit same as that of Example 1 will be omitted.

The return determination unit 38 according to the present example determines whether or not to return the capacity securing movement object to the movement source OSD 40 using each of the capacity threshold value reaching times for the case where the capacity securing movement object is present in each of the movement destination OSD 40 and the movement source OSD 40. In a case where the capacity threshold value reaching time in the case where the current state is maintained is longer than the capacity threshold value reaching time in the case where the return to the movement source OSD 40 is made, the return determination unit 38 requests the service stop prediction unit to calculate a capacity threshold value reaching time in a case where the capacity securing movement object, which is the return determination target, is moved to a movement candidate OSD 40 that is a candidate for the movement other than the movement source OSD 40 and the movement destination OSD 40.

Thereafter, the return determination unit 38 acquires, from the service stop prediction unit 35, the capacity threshold value reaching time in the case where the capacity securing movement object, which is the return determination target, is moved to the movement candidate OSD 40. The return determination unit 38 compares the capacity threshold value reaching time in the case where the current state is maintained with the capacity threshold value reaching time in a case where the capacity securing movement object is stored in the movement candidate OSD 40. In a case where the capacity threshold value reaching time in the case where the capacity securing movement object is stored in the movement candidate OSD 40 is longer than the capacity threshold value reaching time in the case where the current state is maintained, the return determination unit 38 decides the movement of the capacity securing movement object to the movement candidate OSD 40. The return determination unit 38 instructs the object movement control unit 13 of the gateway apparatus 1 to move the capacity securing movement object from the movement destination OSD 40 to the movement candidate OSD 40.

The service stop prediction unit 35 receives, from the return determination unit 38, the request to calculate the capacity threshold value reaching time in the case where the capacity securing movement object, which is the return determination target, is moved to the movement candidate OSD 40. The service stop prediction unit 35 selects an OSD 40 having the longest time until the capacity threshold value is reached from the OSD capacity management table 330. The service stop prediction unit 35 calculates the capacity threshold value reaching time in the case where the capacity securing movement object, which is the return determination target, is moved to the selected OSD 40. Thereafter, the service stop prediction unit 35 outputs the calculated capacity threshold value reaching time to the return determination unit 38 as the capacity threshold value reaching time in the case where the capacity securing movement object, which is the return determination target, is moved to the movement candidate OSD 40.

In the present example, the OSD 40 having the longest capacity threshold value reaching time is set as the movement candidate OSD 40. However, a method of selecting the movement candidate OSD 40 may be another method. For example, the service stop prediction unit 35 may obtain each of the capacity threshold value reaching times in the case where the capacity securing movement object is moved with all the OSDs 40 other than the movement source OSD 40 and the movement destination OSD 40 as the movement candidate OSD 40, and notify the return determination unit 38 of the obtained capacity threshold value reaching time. In this case, the return determination unit 38 selects the OSD 40 having the longest capacity threshold value reaching time in the case where the capacity securing movement object is moved from among all the OSDs 40. The movement candidate OSD 40 may select one or more OSDs 40 as the movement candidate OSD 40 according to the capacity threshold value reaching time, the unwritten capacity, or the like. In a case where there are a plurality of movement candidate OSDs 40, the return determination unit 38 selects the OSD 40 having the longest capacity threshold value reaching time in the case where the capacity securing movement object is moved from among the movement candidate OSDs 40.

In a case where the movement to the movement candidate OSD 40 is determined, the object movement control unit 13 of the gateway apparatus 1 receives, from the return determination unit 80 of the management apparatus 3, the instruction to move the capacity securing movement object from the movement destination OSD 40 to the movement candidate OSD 40. The object movement control unit 13 instructs the movement destination OSD 40 to move the capacity securing movement object to the movement candidate OSD 40. Thereafter, in a case where a movement completion notification of the capacity securing movement object is received from the movement destination OSD 40, the object movement control unit 13 updates the OSD-ID of the movement destination OSD 40, the bucket ID of the movement destination, and the PG-ID of the movement destination of the capacity securing movement object in the object movement plan management table 143 to information on the new movement destination. The object movement control unit 13 notifies the movement source OSD 40 of the information on the movement candidate OSD as the information on the new movement destination OSD 40 together with the object ID of the moved capacity securing movement object.

The movement destination OSD 40 receives, from the object movement control unit 13, the instruction to move the capacity securing movement object to the movement candidate OSD 40. The movement destination OSD 40 moves the capacity securing movement object to the movement candidate OSD 40.

The movement source OSD 40 acquires, from the object movement control unit 13, the information on the movement candidate OSD 40 which is the new movement destination OSD 40 of the capacity securing movement object together with the object ID of the capacity securing movement object. The movement source OSD 40 records the symbolic link including the object ID and the new movement destination OSD 40 of the capacity securing movement object to the position indicated by the hash information obtained from the capacity securing movement object. At this time, the movement source OSD 40 deletes the previous symbolic link.

As described above, in the case where the capacity securing movement object is not returned, the object storage system according to the present example determines whether or not to perform the movement to the other OSD using the remaining capacity threshold value reaching time of the other OSD in the case where the capacity securing movement object is moved. Accordingly, it possible to increase the capacity threshold value reaching time for the entire storage system and thus to more reliably maintain the continuity of the storage service.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing system comprising:
a storage apparatus having a plurality of data storages; and
a processing control apparatus,
wherein the processing control apparatus is configured to:
calculate hash information from data; and
uniquely decide an arrangement destination of the data in the plurality of data storages according to the calculated hash information, and
wherein the storage apparatus is configured to:
move specific data specified as a movement processing target among a plurality of pieces of stored data stored in the data storage from the arrangement destination of the specific data to a movement destination; and
write information on a storage position of the specific data to the arrangement destination of the specific data after the movement.

2. The data processing system according to claim 1, wherein the processing control apparatus is further configured to:
acquire an increase amount of the data in the data storage;
select a movement source data storage that stores data to be moved based on the increase amount of the data; and
instruct the storage apparatus to move the specific data stored in the movement source data storage.

3. The data processing system according to claim 2,
wherein the processing control apparatus is further configured to:
decide a priority of the stored data based on any one or a combination of a size, an access frequency, a preservation timing, or a preservation period of the data; and
select the specific data based on the priority.

4. The data processing system according to claim 2,
wherein the processing control apparatus is further configured to:
decide a movement destination data storage which is a movement destination from among the plurality of the data storages based on the increase amount of the data; and
instruct the storage apparatus to move the specific data to the movement destination data storage.

5. A data processing apparatus comprising:
a memory; and
a processor coupled to the memory and configured to:
calculate hash information from data and uniquely decides an arrangement destination of the data in the memory according to the calculated hash information;
move specific data specified as a movement processing target among a plurality of pieces of stored data stored in the memory from the arrangement destination of the specific data to a movement destination; and
write information on a storage position of the movement destination of the specific data to the arrangement destination of the specific data after the movement.

6. A non-transitory computer-readable recording medium having stored therein a data processing program for causing a computer to execute processing comprising:
calculating hash information from data and uniquely decides an arrangement destination of the data in a data storage apparatus according to the calculated hash information; and
moving specific data specified as a movement processing target among a plurality of pieces of stored data stored in the data storage apparatus from the arrangement destination of the specific data to a movement destination; and
writing information on a storage position of the movement destination of the specific data to the arrangement destination of the specific data after the movement.
